(19) United States
(12) Patent Application Publication
(10) Pub. No.: US 2005/0112454 A1
(43) Pub. Date: May 26, 2005

(54) Alkaline electrolyte fuel cells with improved hydrogen-oxygen supply system

(76) Inventors: Victor Gurin, Boca Raton, FL (US); Peter Novak, Fort Lauderdale, FL (US)

Correspondence Address: AKERMAN SENTERFITT, P.O. BOX 3188, WEST PALM BEACH, FL, 33402-3188, US

(21) Appl. No.: 10/786,943

(22) Filed: Feb. 24, 2004

Related U.S. Application Data
(60) Provisional application No. 60/524,951, filed on Nov. 25, 2003.

(51) Int. Cl. H01M 8/08

(52) U.S. Cl. 429/46; 429/34; 429/13

(57) ABSTRACT

A recirculating hydrogen-oxygen alkaline fuel-cell (AFC) includes an alkaline matrix electrolyte interposed between a porous anode and porous cathode, and an oxygen flow network in fluid connection with the porous cathode. The oxygen flow network has an input portion for supplying oxygen and an output portion for removing oxygen and reaction products after electrochemical reaction. A hydrogen flow network is in fluid connection with the porous anode. The hydrogen network has an input portion for supplying hydrogen and an output portion for removing hydrogen and reaction products after electrochemical reaction. At least one of the oxygen flow network and the hydrogen flow network includes a feedback conduit to form a recirculation loop. The recirculation loop feeds back a portion of the hydrogen or oxygen flow after electrochemical reaction to the input portion.

### CROSS-REFERENCE TO RELATED APPLICATIONS

This application claims the benefit of U.S. Provisional Application No. 60/524,951 entitled “ALKALINE ELECTROLYTE FUEL CELLS WITH IMPROVED HYDROGEN-OXYGEN SUPPLY SYSTEM” filed on Nov. 25, 2003, the entirety of which is incorporated herein by reference.

### FEDERALLY SPONSORED RESEARCH

Not applicable.

### FIELD OF THE INVENTION

The invention relates to hydrogen-oxygen fuel cell generators with alkaline electrolytes, and more specifically to improved hydrogen and oxygen supplies for these systems.

### BACKGROUND OF THE INVENTION

Efficient operation of hydrogen-oxygen electrochemical generators, based on fuel cells of any type, requires maintenance of optimum pressures, temperature and water concentration on the anode and cathode in the face of wide variations in load demand. Such requirements apply to fuel cells having polymer, alkaline matrix, or circulating electrolyte systems. Dynamic systems are often used for removal of water from fuel cells.

Alkaline fuel cells (AFCs) were one of the first fuel cell technologies developed. AFCs were the first fuel cell type widely used in the U.S. space program to produce electrical energy and potable water onboard spacecraft. AFCs are high-performance fuel cells due to the rate at which chemical reactions take place in the cell. They are also very efficient, presently reaching efficiencies of about 40 to 50 percent, exclusive of utilization of generated process heat.

Alkaline fuel cells generally use a solution of potassium hydroxide in water as the electrolyte and can use a variety of non-precious metals as a catalyst at the anode and cathode. When the electrolyte is concentrated, such as about 85 wt % KOH in water, the fuel cells are generally operated at high temperature (˜250° C.), while less concentrated, such as about 30-40 wt % KOH, is generally used for lower temperature (<105° C.) operation. The electrolyte is retained in a matrix (usually asbestos), and a wide range of electrocatalysts can be used, such as Ni, Ag, metal oxides, spinels, and certain noble metals.

The major disadvantage of an AFC is that it is easily poisoned. Thus, the fuel supply is limited to non-reactive constituents except for hydrogen. CO is a poison, and CO₂ will react with the hydroxide electrolyte to precipitate potassium carbonates, thus altering the electrolyte and impacting the catalyst. For example, the catalytic efficiency of the anode can be reduced since the overall number of available catalytically active sites is significantly lowered by poisoning. In addition, the decrease in catalytic activity results in increased over-voltage at the anode and hence the cell is much less efficient adding significantly to the operating costs. Even the small amount of CO₂ in the air can affect the cell's operation, making it necessary to purify both the hydrogen and oxygen used in the cell. This purification process is costly. Susceptibility to poisoning also affects the cell's lifetime (the amount of time before it must be replaced), further adding to its cost.

In operation of an AFC, at the cathode, oxygen, water, and electrons from the anode reaction react in the presence of the cathode catalyst to reduce oxygen and form hydroxyl ions (OH⁻):
1/2O₂+H₂O+2e−→2OH⁻

Hydroxyl ions (OH—) diffuse across the electrolyte toward the anode. The reaction at the anode occurs between the hydrogen fuel and hydroxyl ions (OH⁻) present in the electrolyte, which react to form water and release electrons:
H2+2OH⁻→2H₂O+2e⁻

The flow of electrons from anode to cathode is utilized to provide electrical energy for a load externally connected between the anode and the cathode.

Water that is vaporized into the hydrogen flow stream in the anode chambers of the fuel cell stack (FCS) and is partially re-condensed in a condenser and removed by water-separating pumps. The water is then generally sent to water storage tanks for utility use. In hydrogen-oxygen electrochemical generators, fuel and oxidizer are supplied to the fuel cells stack through respective solenoid valves. Downstream pressure regulators are used as needed to regulate gas flow to accommodate gas consumption by the electrochemical reaction in the fuel cell stacks. Collected gas-phase impurities from cathode and anode chambers are purged via solenoid valves.

Heat exchangers are used to maintain proper operating temperatures. Temperature is controlled by the flow rate of coolant through the heat exchanger liquid loop and the flow of hydrogen through the hydrogen recirculation loop. Temperature sensors are typically installed in the hydrogen outlet and heat exchanger-condenser outlet and are connected to the coolant flow controllers. Coolant temperature control in the fuel cell stack and the condenser in relation to the gas flow (H₂+H₂O vapor) temperature is used to provide adjustment to water vapor concentration. This is generally done by feedback control of the water extraction and condensation rate at the hydrogen recirculation loop outlet.

Combining and synchronizing the hydrogen recirculation with the coolant system improves water concentration in such fuel cells. A shortcoming of these prior systems is the necessity to maintain high temperatures (up to about 127 C) to increase outlet hydrogen vapor concentration under maximum current loads. High fuel cell stack temperature levels can cause corrosion of the electrochemical components and degradation of volt-amp characteristics of the FCS.

Another problem with present designs is the oxygen supply system which is known to determine the reliability of the AFC. Water-free oxygen is fed into the FCS at the single inlet point (“dead end”) from cryogenic storage tank(s). In operation, the FCS temperature is generally between 20 and 95 degrees C., and the vapor partial pressure above the electrolyte (KOH/water solution) is as high as 45-60 KPa.

This condition causes intensive water evaporation at the oxygen entry area to the cathode and matrix, which in turn, leads to increases in local electrolyte concentration in the cathode, matrix pores, and anode. This also accelerates the rate of localized matrix corrosion. Resulting formation of large pores and low electrolyte capillary pressure in localized matrix zones may fail to prevent direct mixing of hydrogen and oxygen within low operational times, such as 300-500 hrs.

With increasing operating time, matrix drying increases. This is due, in part, to the acceleration in corrosion of the cathode and matrix materials and the resulting increased size of the pores filled with electrolyte. A portion of the pores originally filled with electrolyte can become available for gas transfer. At the intermediate cathode surfaces, the amount of evaporation (evaporation rate) is lower.

In the cathode outlet area, water evaporation is much lower during the purge cycle. In this area, the speed of oxygen flow is close to zero, and oxygen is already saturated passing over the cathode inlet and intermediate surfaces. The negative factor of the dehydration increases during the cathode purge cycle with maximum external load and high FCS temperature, which increases water evaporation on the cathode inlet area.

To increase the oxygen supply rate and to remove water vapor from the cathode outlet area, purges can play a positive role. But in the cathode inlet area, due to the localized drying and opening of electrolyte pores, the risk of direct chemical reaction between fuel and oxidant increases. Earlier examples of system designs incorporating oxygen supply to the cathode inlet and outlet reduces somewhat the rate of corrosion, but does not solve the danger of direct mixing of the gases.

Degradation of volt-amp characteristics occur as a result of matrix corrosion, and increased fire danger may result from direct mixing of the gases resulting from matrix degradation. An additional disadvantage of this oxygen supply system is the heterogeneity of the collected inert gas admixtures on working cathode surface between purges. Purge cycles intervals can be up to 12 hours apart.

Independent hydrogen and oxygen supply pressure controllers with individual nitrogen pressure reference connections is another shortcoming of such designs. Undesirable hydrogen/oxygen pressure differential on the fuel cell matrix, as a result of independent gas pressure control, increases resistance to proper gas transport within the matrix. Thus, direct gas reaction and resulting fuel cells fire becomes increasingly probable. When a purge cycle is initiated during periods of maximum external load, the risk of fire is even greater.

Fuel cell design modifications have included simultaneous oxygen supply to the inlet and outlet of the cathode and addition of a solenoid valve. In the FSC operating cycle (valve open), oxygen is fed to the cathode chamber inlet and outlet. In the purge cycle (valve closed), gas flows over the entire cathode surface from inlet to outlet. Implementation of such a design reduces the potential for localized matrix drying by a factor of about two. It also increases the effectiveness of cathode chamber purge. An additional solenoid valve operation can be included in the fuel cell stack automated control system.

Although such modifications reduce matrix degradation and associated problems somewhat, reliability is still poor compared to other fuel cell types and further improvement is needed to improve performance for space and other high end applications, such as space and underwater applications. Stable operation for at least 50,000 hours would be desirable, while to become economically viable, AFC fuel cells need to reach stable operating times exceeding about 10,000 hours. Realization of sufficiently long stable operating times is regarded by many as the most significant obstacle in commercializing AFC technology.

### SUMMARY OF THE INVENTION

A hydrogen-oxygen alkaline fuel-cell (AFC) includes an alkaline matrix electrolyte interposed between a porous anode and porous cathode, and an oxygen flow network in fluid connection with the porous cathode. The oxygen flow network has an input portion for supplying oxygen and an output portion for removing oxygen and reaction products after electrochemical reaction. A hydrogen flow network is in fluid connection with the porous anode. The hydrogen flow network has an input portion for supplying hydrogen and an output portion for removing hydrogen and reaction products after electrochemical reaction. At least one of the oxygen flow network and the hydrogen flow network includes a feedback conduit to form a recirculation loop. The recirculation loop feeds back a portion of the hydrogen or oxygen flow after electrochemical reaction to the respective input portion.

When the oxygen flow network includes a recirculation loop, the oxygen recirculation loop provides a humidified flow to the input portion of the oxygen flow network. The volume of the humidified flow is preferably adjustable, the humidified flow volume increasing with a load on the fuel cell. A jet pump can be included in the oxygen recirculation loop, the jet pump inducing recirculation in the oxygen recirculation loop.

A flow modulator can be fluidicly connected with at least one of an input portion the hydrogen flow network and an input portion of the oxygen flow network to provide a time varying mass flow of hydrogen or oxygen. In a preferred embodiment, the flow modulator is operative across all fuel cell load conditions and a flow modulator is provided in both the hydrogen flow network and oxidant flow network, the respective modulators being communicably connected. The modulated flow can be provided in the form of discrete pulses of hydrogen or oxygen flow. Pulsed flow according to the invention can be provided by a pressure sensor-controlled two-positional pressure regulator having only two positions, a first position being a fully open position and the other position being fully closed.

A method of operating an alkaline hydrogen-oxygen fuel cell (AFC) includes the steps of providing a hydrogen flow to an anode of the fuel cell, and providing an oxygen flow to a cathode of the fuel cell, wherein at least one of the hydrogen flow and the oxygen flow comprises a recirculated flow portion. Both the hydrogen flow and oxygen flow can be time varying flows which are time synchronized to one another.

### DETAILED DESCRIPTION OF THE DRAWING

Specifics of the present invention will become apparent by the following detailed description of the steps by which the invention is practiced as well as by reference to the figure describing the components of the overall invention.

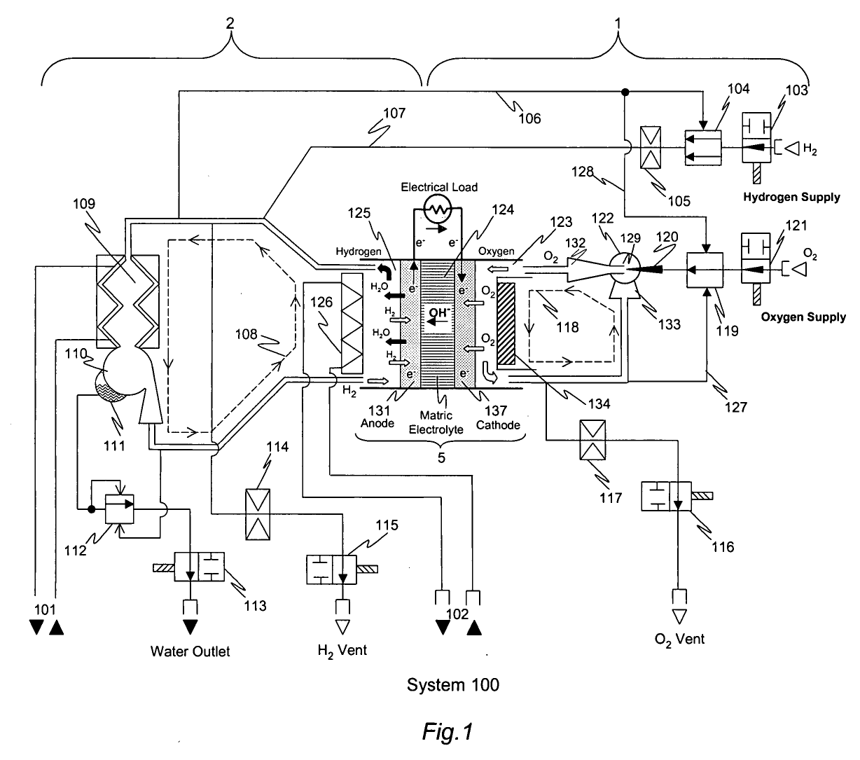

FIG. 1. shows a schematic of a hydrogen-oxygen alkaline electrolyte fuel cell according to an embodiment of the invention.

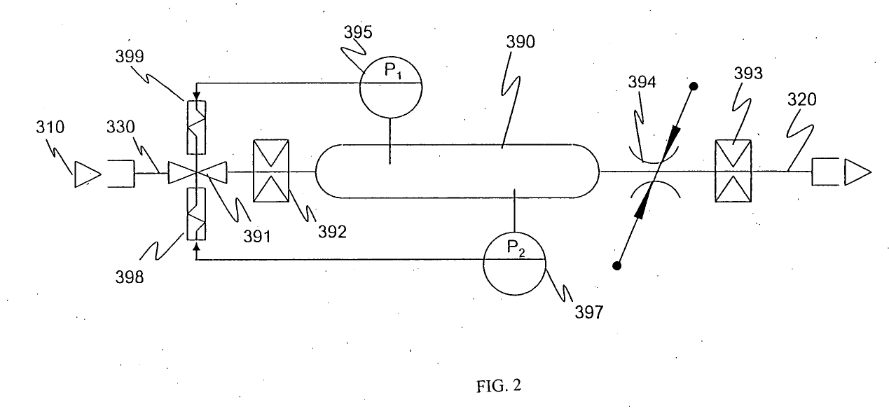

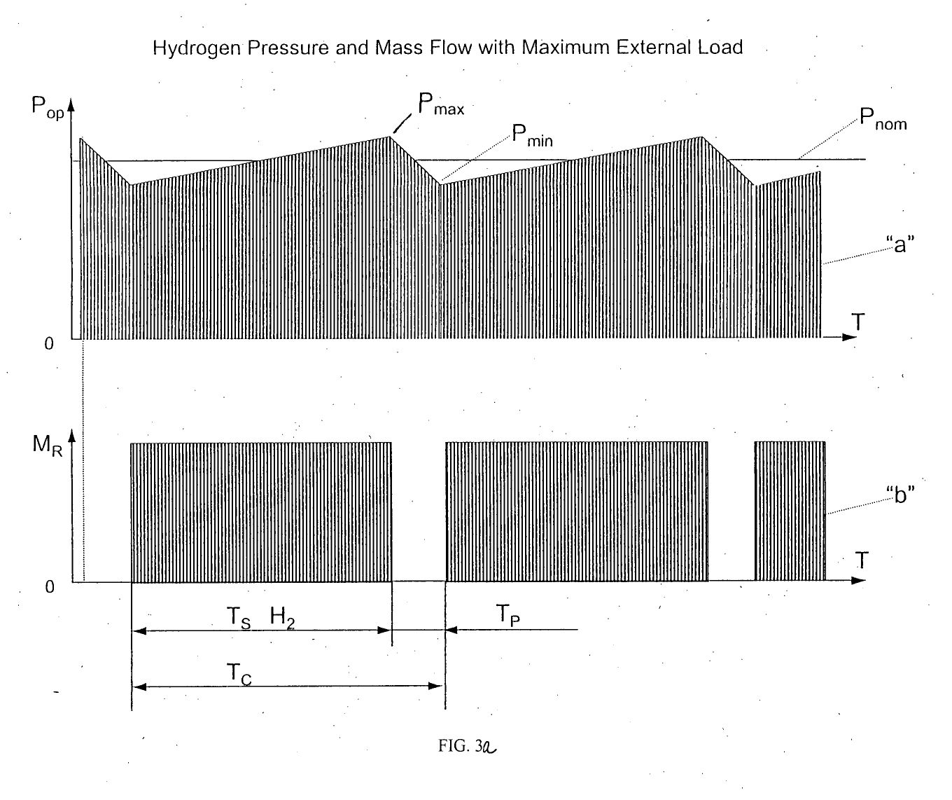

FIG. 2 is a schematic model showing elements of an exemplary regulated gas supply system comprising a closed vessel with variable gas inflow, consumption and outlet flow.

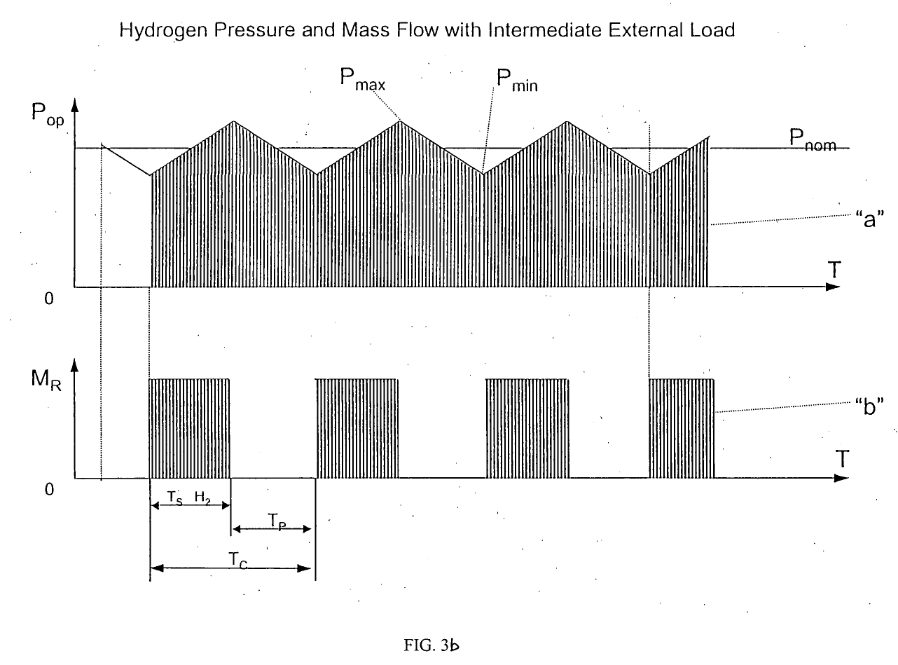

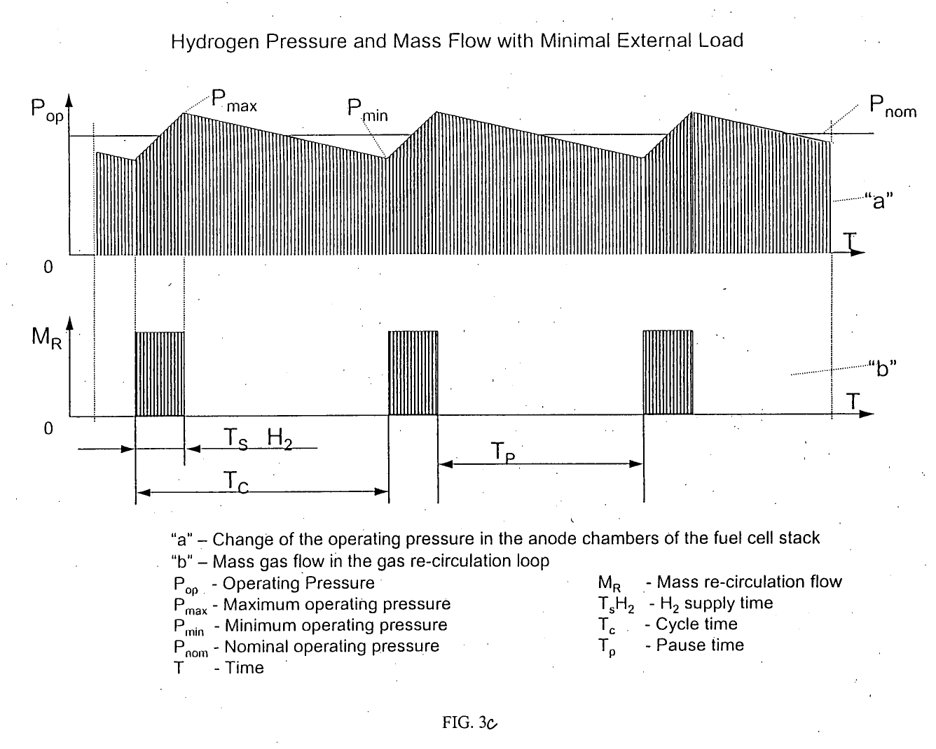

FIGS. 3(a), (b) and (c) show examples of gas supply periods, pauses and cycles of an aperiodic load based reactant flow supply arrangement under relatively high, intermediate and low external load conditions, respectively, according to a preferred embodiment of the invention.

### DETAILED DESCRIPTION OF THE INVENTION

A recirculating hydrogen and oxygen fuel-cell (AFC) includes an alkaline matrix electrolyte interposed between a porous anode and porous cathode. An oxygen flow network is in fluid connection with the porous cathode. The oxygen flow network has an input portion for supplying oxygen and an output portion for removing oxygen and reaction products after electrochemical reaction. A hydrogen flow network is in fluid connection with the porous anode. The hydrogen network has an input portion for supplying hydrogen and an output portion for removing hydrogen and reaction products after electrochemical reaction. At least one of the oxygen flow network and the hydrogen flow network includes a feedback conduit to form a recirculation loop. The recirculation loop feeds back a portion of the hydrogen or oxygen flow after electrochemical reaction to the respective input portion. Efficiency improvements resulting from reactant supply system designs described herein result in significantly reduced weight requirements for the fuel cell stack on a per-watt basis.

Applied to the cathode side, a cathode side recirculation loop feeds back a portion of the oxygen saturated with water vapor from the cathode outlet to the cathode inlet. This arrangement avoids, or essentially eliminates, normal water evaporation from the electrolyte in the cathode inlet region and resulting degradation of inlet region of the fuel cell. With an external load connected, the oxygen and water vapor gas mixture preferably continuously recirculates.

Two conditions must generally be met for optimum AFC-based system operation. These conditions are optimal oxygen supply and electrolyte concentration uniformity. These two conditions are provided by the oxygen circulation loop as described herein. In a preferred embodiment, a gas jet pump and nozzle in the oxygen recirculation loop continuously feeds the FCS cathodes with a humidified oxygen flow.

Referring to FIG. 1, a schematic of a recirculating hydrogen-oxygen fuel cell system 100 according to an embodiment of the invention is shown. System 100 includes fuel cell 5, which includes a matrix electrolyte 124 comprising a alkaline liquid electrolyte solution, such as KOH, supported in a porous matrix interposed between a porous catalyst comprising anode 131 and porous catalyst comprising cathode 137. Cathode chamber 123 is bounded by plate 134 which is disposed adjacent to porous cathode 137, while anode chamber 125 is bounded by flow plate 126 which is disposed adjacent porous anode 131. Porous anode 131 and porous cathode 137 typically comprise electrically conductive carbon. In most practical electrochemical generator applications, system 100 comprises a plurality of fuel cells 5 hooked in series to form a fuel cell stack (FCS). The fuel cell 5 arrangement described herein is not an aspect of the invention.

The reactant gas re-circulation and control arrangement shown in both the cathode side 1 and anode side 2 are aspects of the invention. Beginning first with anode side 2, anode side 2 receives hydrogen fuel from a compressed gas fuel tank and enters the anode supply circuit through two-position solenoid valve 103, pressure regulator 104, and throttle 105. Addition of a two-position type pressure regulator 104 and throttle 105 restricting maximum gas flow in the hydrogen supply system is an aspect of the present invention.

In implementation, it is preferred to incorporate two-position type pressure regulators that allow only two extreme positions of the valve and seat: “Full open” or “full close”. Any intermediate positions of the valve relative to the valve seat in this type of regulator is excluded. According to this preferred embodiment of the invention, a throttle 105 is installed downstream from the relay-type pressure regulator 104. Use of the throttle 105 allows the pressure regulator valve to instantly go into “full open” position because during valve opening, gas pressure increases between the valve and the throttle 105, and the force holding the valve against the valve seat decreases. The throttle 105 also restricts unwanted pressure spikes in the hydrogen re-circulation loop 108. Flow capacity of the throttle 105 is preferably 25-30% higher than FCS hydrogen consumption at maximum external load to allow for purging the anode chamber 125.

Hydrogen passing throttle 105 is then transported to the hydrogen recirculation loop 108 by line 107. The hydrogen recirculation loop 108 comprises a condenser 109, pump 110, water separator 111, and anode chamber 125. Although line 107 is shown connected to an output portion of recirculation loop 108 in FIG. 1, it can be alternatively be connected to the input portion of recirculation loop 108 (not shown) since gas flow in recirculation loop 108 is provided by hydrogen pump 110. Vent throttle 114 and solenoid 115 are in fluid connection with an output portion of recirculation loop 108. Throttle 114 is employed to restrict hydrogen flow during the purge cycle, while solenoid valve 115 is a hydrogen purge valve which is the part an automatic control system (not shown). Solenoid valve 115 can be activated on a time basis or volt-ampere measurement basis to purge the anode chamber 125 of impurities.

A temperature control system 101 including a heat exchanger is coupled to condenser 109 to transfer excess heat out of the hydrogen recirculation loop, such as based on a temperature setpoint Q₁. Excess water is removed from the recirculation loop 108 via regulator 112 and solenoid valve 113.

Hydrogen fuel is circulated through the anode chamber 125 by hydrogen pump 110. Excess heat generated by the electrochemical reaction is removed from the anode chamber by temperature control system 102, which includes a heat exchanger. A pressure feedback control line 106 is used to control hydrogen gas pressure downstream or regulator 104. Regulator 104 is preferably of the type “pressure sensor-controlled two-position pressure regulator”. This preferred type of regulator provides discrete constant pressure pulses of gas flow which have a pulse period and duty cycle (the % of the period in which the regulator is open) in relation to the external load and the gas consumption of the electrochemical reaction, which can be variable over time, and may be highly variable.

Hydrogen line pressure is also sensed by the oxygen line regulator 119 via line 128 which is in fluid connection with pressure feedback control line 106. Although a wired connection is shown in FIG. 1, those having ordinary skill in the art will recognize that the communicable connection of regulators 104 and 119 can be over the air, or via a pneumatic line as well. For example, the controlling set point of the regulator 104 can be used as a reference point for the regulator 119. Such a connection between hydrogen regulator 104 and oxygen regulator 119 provides synchronization of their operation. When regulators 104 and 119 are pressure sensor controlled two position pressure regulators, oxygen pressure pulsations in the cathode chamber 123 and hydrogen pressure pulsations in the anode chamber 125 become synchronized.

Oxygen is supplied to the cathode circuit 1 from a dry oxygen storage via solenoid valve 121 and pressure regulator 119 through nozzle 120 to a pump 122. Pump 122 is preferably a jet pump.

Jet pumps are preferred due to their substantially proportional relation between consumption of recirculation streams and used gases in the fuel cells during the current production. Additional positive characteristics of such pumps as compared to electromechanical pumps include the absence of electrical energy use, high reliability, and essentially unlimited time in operation. Jet pump 122 can be driven entirely by potential energy of the compressed oxygen (e.g. stored in reactant tanks). Although jet pumps are preferred, other pump types may be used with the invention.

Jet pump 122 provides for mixing of the dry oxygen from storage tanks with wetted oxygen from the outlet zone of the cathode chambers. Since oxygen in the cathode outlet is saturated and pump 122 provides mixing of the water saturated oxidant with dry oxygen, generally in a ratio of 3:1 to 7:1, the normal water evaporation from the electrolyte in the cathode inlet region does not take place. This also applies during the cathode chamber purge cycle. This process takes place in the inlet zone for the cathodes. To provide an optimal oxidant flow to the tri-phase region, the wetted oxygen flow area boundary preferably includes the entire cathode surface.

Oxygen gas passing through nozzle 120 forms a high-velocity stream in the mixing chamber 129. This high-speed stream generates a lower pressure region at its boundary (according to the Bernoulli principle) and thereby sucks in recirculated gas from recirculation line 118 via receiving chamber 133. The two streams of air are directed into the mixing chamber 129 where their speed is equalized due to the mixing. The mixed stream then passes through a diffuser 132, where the stream is expanded, and the static pressure increases.

The coefficient of injection characterizes the ratio between the mixing mass flow of recirculated oxygen from the cathode chamber 123 of the fuel cell 5 in relation to oxygen flow received via nozzle 120 into oxygen recirculation loop 118. The degree of compression of the mixed airflow output by pump 122 corresponds to aerodynamic resistance of the recirculation loop 118 when oxygen consumption is equal to consumption at the stream pump outlet.

Jet pump 122 is preferably optimized relative to a number of parameters. The following operational parameters preferably include:
1. the gas pressure at the nozzle inlet 120;
2. the gas pressure in the receiving chamber 133;
3. the coefficient of injection which is equal to ratio between the mass of injected gasses from receiving chamber 133 and the mass of the gasses ejected from stream pump nozzle;
4. the compression ratio of the mixed stream, which is equal to the ratio between pressures of the mixed stream at diffuser outlet 131 and the pressure of the injected stream in the receiving chamber of the pump 122.

Throttling of the air stream occurs by passing the oxidant stream through the valve nozzle 120 of jet pump 122. The pressure regulator 119 then enables stabilizing amount of oxidant gas going through the jet pump 122 in the face of arbitrary changes in oxygen consumption in the fuel cell stack. The optimal upper and lower levels of oxygen pressure on the cathode can be selected for each specific type of porous media.

Returning again to FIG. 1, jet pump 122 induces recirculation flow through the oxygen recirculation loop 118. This loop comprises jet pump 122, cathode chamber 123. Pressure sensing feedback line 127 is in fluid connection with recirculation loop 118. Humidified oxygen exiting the cathode chamber 123 is introduced into the fresh oxygen feed line via jet pump 122. A portion of the unused oxygen and impurities (mainly inert gasses) are vented from the oxygen cathode chamber 123 and recirculation loop 118 via throttle 117 and solenoid valve 116.

The invention includes a dynamic system for water extraction from the AFC fuel cells. Such systems are well known and widely used in electrochemical generators. For this purpose, the hydrogen recirculation circuit 108 includes a condenser 109. In a AFC stack, the working pressure of hydrogen in the anode chambers, as well as oxygen pressure of the cathode chambers must generally be maintained be in the range of 0.3-0.45 MPa. This pressure range is required in order to produce the optimal energy characteristics for the fuel cells comprising the FCS.

As a rule, the capacity of the hydrogen recirculation loop in an FCS with matrix electrolyte is 3.5-5 times greater than the cathode chamber capacity. This ratio is explained by the water vapor condenser 109, which is part of the hydrogen recirculation loop, and the large capacity of the hydrogen cavities in the fuel cell stack, particularly that of the anode chambers.

Anode chamber 125 generally includes gas transport panel/gas distribution tray assemblies with large pores and channels for hydrogen and water vapor circulation. One more determining factor in the ratio between anode and cathode capacities is the necessity for adequate hydrogen circulation in the loop to effectively remove water from anodes. This allows transfer of water vapors contained in the hydrogen gas flow from the anodes to the condenser 109 at maximum current load.

For example, the mass flow of the re-circulating hydrogen flow preferably exceeds the hydrogen consumption of the FCS by generally more than 20 fold. Considering the difficulties in pumping hydrogen, the resistance in the hydrogen loop has to be small, on the order of 100-150 mm of water at maximum hydrogen flow. Therefore, the hydrogen recirculation loop 108 and anode chambers 125 are preferably constructed with large cross-sectional areas to reduce the energy consumption of the hydrogen pump drive. Hydrogen pump performance and the speed of the recirculating flow comprising hydrogen and water vapor should be selected in relation to the electrolyte concentration in the electrochemical group comprising the anode, matrix, cathode, FCS temperature, and hydrogen temperature at the condenser 109 outlet.

At high temperatures, the hydrogen stream is saturated with water vapor in the anode chambers 125 and directed to the condenser 109 where temperature of the hydrogen stream is substantially reduced by heat exchanger 101 and a portion of the water vapor is condensed forming water drops.

The hydrogen stream, together with condensed water, is fed to the hydrogen pump 110 where water and gas are separated. Water collected at the periphery of the pump 110 in a water-separating device is directed through the regulator 112 and solenoid valve 113 into a suitable vessel (not shown). The FCS temperature, with the external load disconnected, is controlled by coolant re-circulation/heat exchanger 102.

Another aspect of the invention involves use of pressure pulsation in the reactant flows. In the preferred embodiment shown in FIG. 1 where regulators 104 and 119 are communicably connected, pressure pulsation in the hydrogen supply circuit leads to pulsations in the oxygen supply pressure when the fuel cell is under load. In the preferred embodiment shown in FIG. 1, a two-position type pressure regulator 104 is connected with measuring feedback line 106 to the hydrogen circulating circuit 108 to accomplish downstream pressure control. Hydrogen supply to the anode 131 can also be achieved by employing a two-stage pressure sensor installed in the hydrogen recirculation loop 108 along with a solenoid valve to open and shut off gas flow at the inlet, as shown in FIG. 2, instead of a two position type pressure regulator. Pressure pulsations are generated in the oxygen supply by sensing of hydrogen loop pressure via line 128 and internal oxygen loop supply pressure using oxygen loop pressure feedback line 127.

Pulsed hydrogen supply to the fuel cell stack anode 131 provides significant advantages including continuous replenishment of the current-generating surfaces within the anode 131, while providing active removal of impurities from the anode gas transporting pores. With the external load connected, gas pressure changes induced in the anode chamber 125 affect the location of the anode tri-phase boundary where the electrochemical reaction occurs. Specifically, the tri-phase interface of the gas, catalyst, and electrolyte, where the reaction H(+)+OH(—)→H₂O takes place is moved back and forth within the porous materials of the anode according to the pressure of the hydrogen gas. Changes in the position of this “tri-phase” boundary in the anode with changing pressure take place because of electrolyte movement inside the anode pores. Such movement is made possible by non-uniform pore structure of the anode. These pressure pulsations give rise to continuous replenishment of the current-generating surfaces within the anode. In addition, active removal of impurities from the anode gas transporting pores is achieved.

According to the present invention, hydrogen pressure pulsations generally range ±15% from an optimum nominal operating pressure, such as 0.3-0.5 MPa. These pressure variations do not affect the process of water extraction from anode 131. This is because anode chambers 125 have hydrogen gas distribution channels that have substantial volume being up to 85% of the entire volume of the gas transport pores. The effective diameter of the anode distribution plate pores is generally about 2.5-15 times larger than anode pores. When pulsating gas pressure is applied to anode gas transport pores, small pores can absorb a portion of electrolyte squeezed from anode, and larger pores are left open for gas flow. Therefore, changes in gas pressure do not obstruct effective gas flow to the anode 131.

Pulsed oxygen supply to the fuel cell stack cathode 137 provides significant advantages. The current load on the FCS also determines the interval between pressure pulses of the oxygen flowing through the nozzle 120. During oxygen pulsation, active ventilation of the cathode chamber 137 takes place. Humidified oxygen is fed to the cathode inlet, which eliminates localized cathode and matrix drying, and in the outlet zone oxidant supply. Due to synchronized pressure changes in the hydrogen and oxygen supplies, alterations in electrolyte position in the anode and cathode capillary pores comprising the tri-phase boundary takes place. The rate of this transient process increases with changing current loads.

FIG. 2 shows a schematic model of elements of an exemplary regulated gas supply system comprising a closed vessel with variable gas inflow, consumption and outlet flow. As noted above, pressure regulators 104 and 119 are preferably of the type “pressure sensor-controlled two-positional pressure regulator”. System 200 is a model for gas supply using such a regulator to a fuel cell with variable consumption in response to the speed of a chemical or electrochemical reaction.

A gas (pressurized air for example) from a source 310 is modeled as having an infinite volume and pressure. For example, the pressure provided P₁=0.5 MPa can be introduced into the vessel 390 via pipe 330 which has a two-position pressure regulator 391 including two solenoids, namely 399 to open and 398 to close. Assume that pressure in the vessel 390 is desired to be maintained at a stable level, such as P_{work}=0.3±0.03 MPa.

A regulation throttle 392 is installed between pressure regulator 391 and the vessel 390 for restriction of gas flow. Gas flows through pipe 320 which has a non-regulated throttle 393 to restrict exiting gas flow and a controlling throttle 394, which reduces gas flow in pipe 320. On vessel 390, pressure sensors 395 and 397 are installed with different pressure regulating parameters to operate solenoids 399 and 398, respectively.

Design of the two-position pressure regulator 391 allows only two extreme positions of the valve and saddle, “fully open” and “fully closed.” Any intermediate positions of the valve relative to the saddle are not possible. Throttling of the gas stream entering the vessel 390 occurs only at the throttle 392. Gas can exit the vessel only through the pipe 320 at a variable flow rate controlled by the flow area changing of the regulating throttle 394. Maximum consumption of the effluent gas through the pipe 320 is limited by the flow area of the unregulated throttle 393. It is assumed that the maximum gas inflow rate to the vessel through the pipe 330 is 1.5 times the maximum gas consumption from the vessel through the pipe 320.

The object of system 200 is to control of the pressure in the vessel 390 under conditions of variable gas effluent rates from the vessel. Two pressure sensors 395 and 397 are installed on the vessel 390. If the pressure is lower than some pre-determined level (for instance, P_{work}=0.275 MPa) the first pressure sensor 395 will command the pressure regulator 391 to open. If the pressure is higher than some pre-determined level (for instance, P_{work}=0.320 MPa) the second pressure sensor 397 will command the pressure regulator 391 to close. As a result, system 200 delivers discrete pulses of gas at a constant pressure to vessel 390.

FIG. 3(a) shows the gas supply period, pauses and cycles under relatively high load conditions. Under the high load conditions, the cycle time (Tc) which comprises a supply time (Ts) plus the pause time (Tp) provides a little over two (2) periods in the time T₁. The supply time (Ts) is nearly equal to the cycle time (Tc). When the regulator is open the operating pressure (Pop) rises as a function of time until the time when Pop reaches Pmax, then the regulator shuts off. While the regulator is off, the operating pressure decreases until P_{Min} is reached, and the regulator is turned on again. FIG. 3(b) shows the gas supply period, pauses and cycles under moderate load conditions. Under the moderate load conditions, almost five cycles are provided in the time T₁, while the supply time Ts is about 0.5 Tc. Finally, FIG. 3(c) shows the gas supply period, pauses and cycles under relatively low load conditions. Under the low load conditions, about three cycles are provided in the time T₁, while supply time Ts is about 0.2 Tc.

Compiling the data from FIGS. 3(a)-(c), the supply time Ts increases as the load increases. In addition, the mass recirculation flow M_{R} increases with increasing load.

Thus, the preferred pressure sensor-controlled two-positional pressure regulator” can be characterized as a pulse gas supply and recirculation where the pulse dynamics change as a function of load. A difference between the reactant flow characteristics obtained using the preferred pressure regulator as disclosed herein as compared to pulsed reactant systems such as disclosed in U.S. Pat. No. 6,093,502 to Carlstrom, Jr. et al. is the simultaneous variation of pulse width and pulse period in relation to the external load and gas consumption rate of the electrochemical reaction provided by the invention. In addition, Carlstrom's pulsed system is only activated upon detection of a predetermined high load level, while the pulsed gas supply of the invention is preferably operable over all load conditions.

In conventional solutions to this problem, a “balanced-type” pressure regulator controls the gas supply to the fuel cell. The “balanced-type” pressure regulator in such a circuit has a measuring space directly after the valve saddle and throttling of the gas pressure occurs in the gap between the valve and saddle. Such regulators can replace both pressure sensors 395 and 397 and the two-position regulator 391.

The recirculated oxygen gas flow together with pulsed and synchronized hydrogen and oxygen gas flow according to the invention provides numerous advantages over available AFC-based systems. For example, Table 1 below compares features and performance of an alkaline hydrogen-oxygen fuel cell stack having a reactant supply system according to the invention to an alkaline hydrogen-oxygen fuel cell having a conventional reactant supply system, with other system components and settings being the same:

TABLE 1
Comparative features and performance of an alkaline fuel cell stack.

| | | Hydrogen/Oxygen Fuel Cell Fitted with |
|---|---|---|
| Parameter/Design | Conventional Hydrogen/Oxygen Fuel | Hydrogen-Oxygen Re-circulation System |
| Feature | Cell Design | According to the Invention |
| Hydrogen and | Oxygen and hydrogen supply systems | Oxygen and hydrogen supply pressure is pulsed |
| Oxygen Supply | with pre-determined constant pressure | by as much as 7.5% of the nominal operating |
| Systems Pressure | | pressure to: |
| | | a) replenish current-generating surface, and |
| | | b) provide active removal of impurities. |
| Oxygen and | Independent oxygen and hydrogen supply | Oxygen and hydrogen pressure controllers are |
| Hydrogen | pressure controllers with individual | interconnected and synchronized thus |
| Pressure Controllers | nitrogen pressure reference connections | preventing pressure differential and reducing |
| | can lead to undesirable pressure | fire danger. |
| | differential on matrix, which can cause | |
| | direct mixing of gases and even fire, | |
| | especially under maximum loads or during | |
| | purge cycles. | |
| Oxygen Feed System | Oxygen supply system to feed “dry” | Implementation of proposed oxygen re- |
| Design | oxygen from the storage tank(s) to the | circulation loop wherein “dry” oxygen from the |
| | cathode inlet or in some designs to the | storage tank(s) is mixed with saturated oxygen |
| | inlet and outlet simultaneously does not | from the cathode outlet in a proportion of about |
| | prevent matrix drying, corrosion and the | 3:1 to 7:1 and fed back to cathode inlet to |
| | risk of the direct mixing of the gases. | provide: |
| | | a) improved matrix hydration; |
| | | b) electrolyte concentration uniformity; |
| | | c) improved fire safety; |
| | | d) improved volt-ampere characteristics, and |
| | | d) prevention of direct mixing of gases |
| Internal Power | Internal power consumption: | Internal power consumption: |
| Consumption | 2 kW (internal) for 7 kW (output) | 0.3 kW (internal) for 17 kW (output) |
| | 2 kW (internal) for 12 kW (max. output) | 0.3 kW (internal) for 35 kW (max. output) |
| Rate of Performance | Rate of voltage degradation during | Rate of voltage degradation during operation |
| Degradation | operation with current density 0.25 A/sm²: | with current density 0.25 A/sm²: |
| | 0.9 mV/24 hrs. | 0.1 mV/24 hrs. |
| Anticipated Service | Required Maintenance Intervals: | Required Maintenance Intervals: |
| Life | 2000 hr maximum | 7,000 to 10,000 hr. |

Systems according to the invention are thus particularly well suited for use in fuel cells for aerospace and undersea applications. In addition, the high efficiency, together with long stable operating lifetimes and high reliability provided by the invention may avail AFC-based systems according to the invention to be useful for a wide variety of commercial applications.

### EXAMPLE

It should be understood that the examples and embodiments described herein are for illustrative purposes only and that various modifications or changes in light thereof will be suggested to persons skilled in the art and are to be included within the spirit and purview of this application. The invention can take other specific forms without departing from the spirit or essential attributes thereof.

The invention was implemented as a prototype AFC stack comprising 96 cells. The size of the cells in the stack was approximately 200 cm². The stack was operated and monitored for more than 5000 hours. Principal operating parameters and selected test data are shown in Table 2 below. During the testing process, the hydrogen supply system employed a two-position type regulator and throttle as described above to established pressure pulses in the hydrogen gas supply performed steadily over the entire range of external loads for which the system was designed to be (0-7.5 kW). During the tests performed, short duration periodic pressure increases in the hydrogen supply (up to 1.35 MPa) resulted in no detectable change in performance.

The oxygen supply system also performed as described providing the intended synchronized pulsation in the anode supply and anode chambers relative to the cathode supply with small increases up to 0.01-0.02 MPa. No anomalies in the system performance were recorded during cycling of the external load from 0.1 kW to 7.5 kW. Also, the degradation rate of the volt-amp characteristics was reduced by more than 2 fold relative to that of existing systems, namely 3.8×10⁻² mV per cell per hour as compared to 1.7×10⁻² mV per cell per hour.

Anode, cathode and matrix electrolyte structures were analyzed by using cross sectioning and photomicrography subsequent to the test and no changes were found in the physical structures of these components. This lack of deterioration demonstrated the beneficial effects of the present invention relative to the service life and the performance of these components and the overall system according to the invention. it is estimated that the service life of AFC-based systems according to the invention will generally be at least 5,000 hours.

TABLE 2
Principal operating parameters from a 5,000 hr demonstration
of a preferred embodiment of the present invention.

| Operating Data from Fuel Cell Stack System | Operating Parameter |
|---|---|
| of the Present Invention (5000 hrs operation) | Value |
| Variation in External Load | 0.1 kW-7.5 kW |
| Output Voltage | 27.5-37 VDC |
| Working Temperature | 90-95 Degrees C. |
| Inlet Oxygen and Hydrogen Gas Pressure | 0.75-0.85 MPa |
| Hydrogen Pressure in Anode Chambers | 0.41-0.45 MPa |
| Combined Volume of the Hydrogen Chambers | 8.5 × 10⁻³ m³ |
| (including re-circulation loop) | |
| Oxygen Pressure in Cathode Chambers | 0.42-0.47 MPa |
| Combined volume of the oxygen chambers | 2.7 × 10⁻³ m³ |
| (including re-circulation loop) | |

While various embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

1. A recirculating hydrogen-oxygen alkaline fuel-cell, comprising:
an alkaline matrix electrolyte interposed between a porous anode and porous cathode;
an oxygen flow network in fluid connection with said porous cathode, said oxygen flow network having an input portion for supplying oxygen and an output portion for removing said oxygen after electrochemical reaction, and
a hydrogen flow network in fluid connection with said porous anode, said hydrogen network having an input portion for supplying hydrogen and an output portion for removing hydrogen after electrochemical reaction, wherein at least one of said oxygen flow network and said hydrogen flow network includes a feedback conduit to form a recirculation loop, said recirculation loop feeding back a portion of said hydrogen or said oxygen after electrochemical reaction to said input portion.

2. The fuel cell of claim 1, wherein said oxygen flow network includes said recirculation loop, said recirculation loop providing a humidified flow to said input portion of said oxygen flow network.

3. The fuel cell of claim 2, wherein a volume of said humidified flow is adjustable, said humidified flow volume increasing with a load on said fuel cell.

4. The fuel cell of claim 2, wherein said fuel cell includes a jet pump in said oxygen recirculation loop, said jet pump inducing recirculation in said oxygen recirculation loop.

5. The fuel cell of claim 1, wherein both said oxygen flow network and said hydrogen flow network includes a recirculation loop.

6. The fuel cell of claim 1, further comprising a flow modulator fluidicly connected with at least one of an input portion said hydrogen flow network and an input portion of said oxygen flow network, wherein said modulator provides a time varying mass flow of said hydrogen or said oxygen.

7. The fuel cell of claim 6, wherein said modulator is operative across all fuel cell load conditions.

8. The fuel cell of claim 6, wherein said hydrogen flow network includes a first modulator and said oxidant flow network includes a second modulator, said first and second modulator being communicably connected.

9. The fuel cell of claim 6, wherein said flow modulator provides discrete pulses of hydrogen or oxygen flow.

10. The fuel cell of claim 6, wherein said modulator comprises a pressure sensor-controlled two-positional pressure regulator having only two positions, a first position being a fully open position and the other position being fully closed.

11. A method of operating an alkaline hydrogen-oxygen fuel cell (AFC), comprising the steps of:
providing a hydrogen flow to an anode of said fuel cell, and
providing an oxygen flow to a cathode of said fuel cell, wherein at least one of said hydrogen flow and said oxygen flow comprises a recirculated flow portion.

12. The method of claim 11, wherein said oxygen flow comprises a recirculated flow portion, wherein said recirculated flow portion is humidified.

13. The method of claim 11, wherein at least one of said hydrogen flow and said oxygen flow is a time varying mass flow, said mass flow varying with a load on said fuel cell.

14. The method of claim 13, wherein said time varying mass flow is operative across all loads on said fuel cell.

15. The method of claim 13, wherein said time varying mass flow comprises discrete pulses.

16. The method of claim 11, wherein both said hydrogen flow and said oxygen flow is a time varying mass flow, further comprising the step of time synchronizing said mass flow of said hydrogen flow with said mass flow of said oxygen flow.
